(19) United States
(12) Patent Application Publication
(10) Pub. No.: US 2014/0111641 A1
(43) Pub. Date: Apr. 24, 2014

(54) METHOD OF SENDING AND PROCESSING EVENT IMAGES

(71) Applicant: CANDID COLOR SYSTEMS, INC., Oklahoma City, OK (US)

(72) Inventors: Jack E. Counts, JR., Sunny isles Beach, FL (US); Robert Lynn Porter, Edmond, OK (US)

(73) Assignee: Candid Color Systems, Inc., Oklahoma City, OK (US)

(21) Appl. No.: 13/792,717

(22) Filed: Mar. 11, 2013

Related U.S. Application Data
(63) Continuation of application No. 13/656,431, filed on Oct. 19, 2012.

(51) Int. Cl. G06F 3/00

(52) U.S. Cl. CPC G06F 3/005
USPC 348/143; 348/207.1

(57) ABSTRACT

A method of automatically processing photography is provided wherein a digital image is received by an automated process through digital message and processed. The processed image is subsequently returned to the customer using a digital messaging system.

### CROSS REFERENCE TO RELATED APPLICATIONS

This application is a continuation in part of prior U.S. patent application Ser. No. 13/656,431, filed Oct. 19, 2012.

### BACKGROUND OF THE INVENTION

1. Field of the Invention

This invention relates generally to the field of photography, and more specifically to digital photography and processing of digital photography.

2. Description of the Related Art

The growing popularity of digital cameras has spawned websites for users to upload pictures and choose image related products such as photographic prints and t-shirts or other products bearing the image. Generally, current processes rely on a customer or photographer to access a website and upload the digital images, which can be cropped and modified prior to uploading. Once the images have been uploaded, the customer can access the website to request photographic prints and/or other products. Additionally, if the image is to be processed or customized by the operator of the website, the customer must wait for manual processing and customization by the operator.

Although such websites represent a significant advancement in the ease and speed of obtaining photographic prints and related products, they still can be slow and unresponsive to the needs of the customer. For example, for special events such as graduations, sporting events and celebrations it is often inconvenient to have to wait until after the event to upload the digital images to a computer followed by uploading to a website. Additionally, the delays in processing and customizing a digital image can hamper spontaneous event purchases. Accordingly, a more responsive process for processing digital images is desirable.

### SUMMARY OF THE INVENTION

In accordance with one embodiment of the invention there is provided a method of processing digital images comprising:
(a) receiving a digital image sent by a first digital message;
(b) extracting a return address from the first digital message by an automated processor;
(c) extracting the digital image from the first digital message by the automated processor;
(d) processing the digital image by the automated processor to produce a processed image; and
(e) returning the processed image to the return address by a second digital message wherein the second digital message is sent by the automated processor.

In accordance with another embodiment of the invention there is provided a method of processing digital images comprising:
(a) receiving a digital image sent by a first digital message wherein the image has a subject in front of a background;
(b) extracting a return address from the first digital message by an automated processor;
(c) extracting the digital image from the first digital message by the automated processor;
(d) processing the digital image by the automated processor to produce a processed image wherein the processing comprises superimposing; and
(e) returning the processed image to the return address by a second digital message wherein the second digital message is sent by the automated processor.

### BRIEF DESCRIPTION OF THE DRAWINGS

FIG. 1 is a flow chart of one embodiment of the inventive method.

FIG. 2 is a diagram illustrating an overview of one embodiment of the method of the current invention.

FIG. 3 is a diagram illustrating the evaluation of image quality in greater detail.

FIG. 4 is a flow chart illustrating the processing steps for superimposing an image on a background in accordance with one embodiment of the invention.

FIG. 5A is a illustration of an event specific background that can be used as a predetermined background for background replacement via chroma key processing or superimposing in accordance with some embodiments of the invention.

FIG. 5B is an illustration of an image with the background replaced with the predetermined background illustrated in FIG. 5A in accordance with using a chroma key system for processing.

FIG. 5C is an illustration of an image superimposed on the predetermined background of FIG. 5A in accordance with the embodiment FIG. 4.

### DESCRIPTION OF THE PREFERRED EMBODIMENTS

Broadly, the methods of this invention comprise the phases of image capture, image transmission, processing, return transmission and sales.

The image capture phase can occur at any location. Generally, the location will be at an event such as a celebration, graduation, race, sports game or similar. The method is applicable to using the native backgrounds, either natural or constructed, available at the location but it is advantageous to use a special assembly such as a chroma key background, as further explained hereunder. Basically, the subject will pose in front of the background and another person will use a cell phone camera, digital camera, or other digital capture device to capture an image of the subject. The person using the digital capture device can be a professional photographer but does not have to be and, thus, can be anyone attending the event. For ease of reference, the person using the digital capture device to capture the digital image will be referred to hereinafter in the specification and claims as the “photographer” even though the person may not be a professional photographer.

The transmission phase comprises a person sending a digital message containing the digital image to an automated processor. The person sending the digital message can be the photographer, the subject, or any other person such as a person attending the event, a sponsor of the event, or a person associated with organizing the event. For ease of reference, the person sending the digital message containing the digital image will be referred to hereinafter in the specification and claims as the “customer.” The transmission of the image can occur via e-mail, text messaging or any other suitable digital messaging transmission method. The digital message can be sent to a predefined digital messaging address, which can be unique to each event. The image transmission can occur immediately after capture of the image or at any time after the capture of the image. This transfer could even occur at the customer's home or office after transfer of the image to a computer.

The next phase is processing of the digital image. During processing of the digital image, a return digital address associated with the customer is extracted from the digital message and the digital image is extracted from the digital message. After extraction of the digital image, the image can be stored in a database and can undergo further predetermined processing steps such as changing the background, superimposing all or a portion of the digital image onto a predetermined background, superimposing a predetermined foreground onto the digital image, sub-sampling the digital image and changing the digital image format. Such processes are further described below.

In the return transmission phase, a digital message is sent to the customer. Additionally, a digital message can be sent to a sponsor, event organizer, photographer or other person associated with the event that has an interest in the digital images captured at the event. Generally these will be referred to hereinafter in the specification and claims as “event associate.” The digital messages can include a copy of the processed digital image and/or a webpage link.

The sales phase involves the customer or event associate accessing the webpage. The sales phase can involve a third party accessing the webpage, such as where the customer or event associate allows access to the webpage to a third party. The person accessing the webpage will be referred to hereinafter in the specification and claims as the “user.” At the webpage, the user can have the option of exchanging backgrounds, cropping the picture, or making other changes to the digital image as further described below. After making such changes, if any, the user can order copies of the image in front of any of the alternative backgrounds and chose print sizes or products (that use the image on the product). The user pays for the order electronically and the order will be submitted to a fulfiller for fulfillment. When the order is fulfilled, the product(s) will be sent to the user.

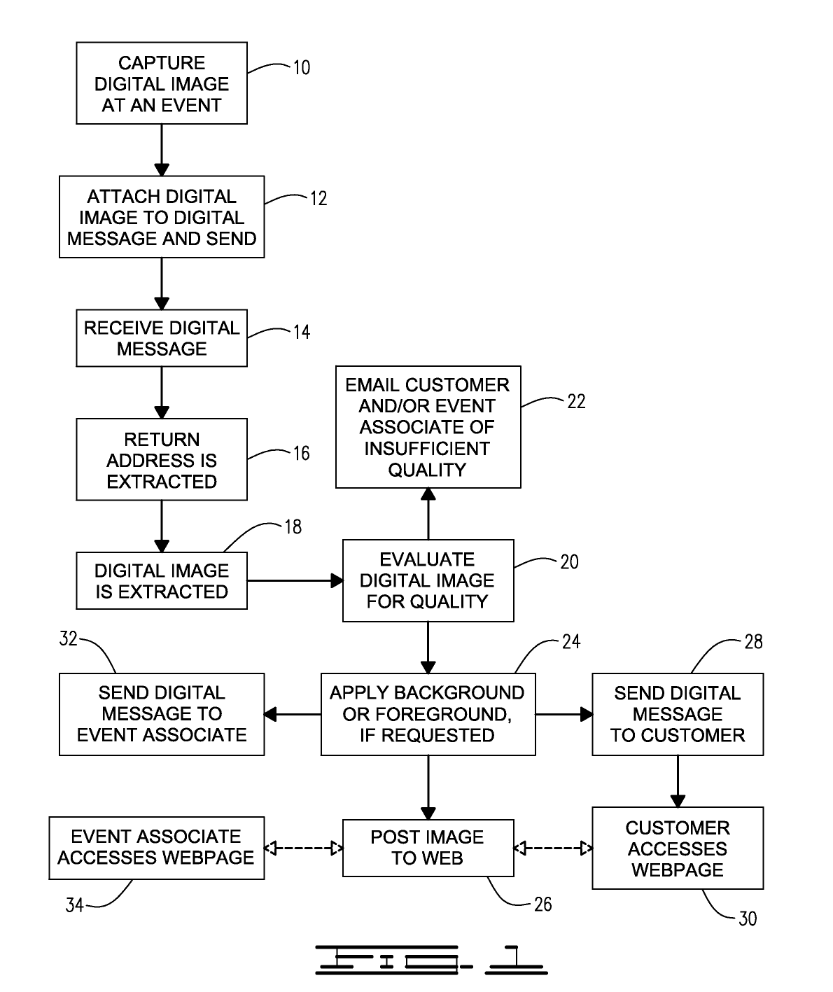

With reference to FIG. 1, the invention will now be described in greater detail. FIG. 1 is a flow diagram of a method in accordance with the invention. As shown in step 10, the photographer captures a digital image at an event. The digital image is captured using any suitable digital capture device but will generally be a cell phone camera, digital camera, or other device capable of capturing a digital image. Although any such suitable digital capture device can be used, it is preferred that the digital capture device also be a device having digital messaging capability as this will facilitate the sending of the digital message to the automated processor and the subsequent return of the processed digital image and/or webpage link during the course of the event instead of subsequent thereto. Preferred digital capture devices have at least a 2-megapixel capability and can be at least a 4-megapixel capability. Digital capture devices of less than 2-megapixel can be used; however, image quality may suffer and, thus, images from such lesser megapixel devices may cause a warning message to be delivered, as discussed below.

As mentioned above, the subject will pose in front of a background and the photographer will capture the digital image with the digital capture device. The background can be selected from the native backgrounds, natural or constructed, occurring at the event location or can be a special assembly such as a chroma key background. To achieve full and ready replacement of the background of the invention, it is desirable that the background be a chroma key background. Superimposing can be used to achieve a partial or complete replacement of the background, as explained below, but it is much more difficult to achieve as refined a processed image as can be achieved with a chroma key process. The advantage of superimposing is that it does not require a chroma key background but can be used with the native backgrounds at the event location.

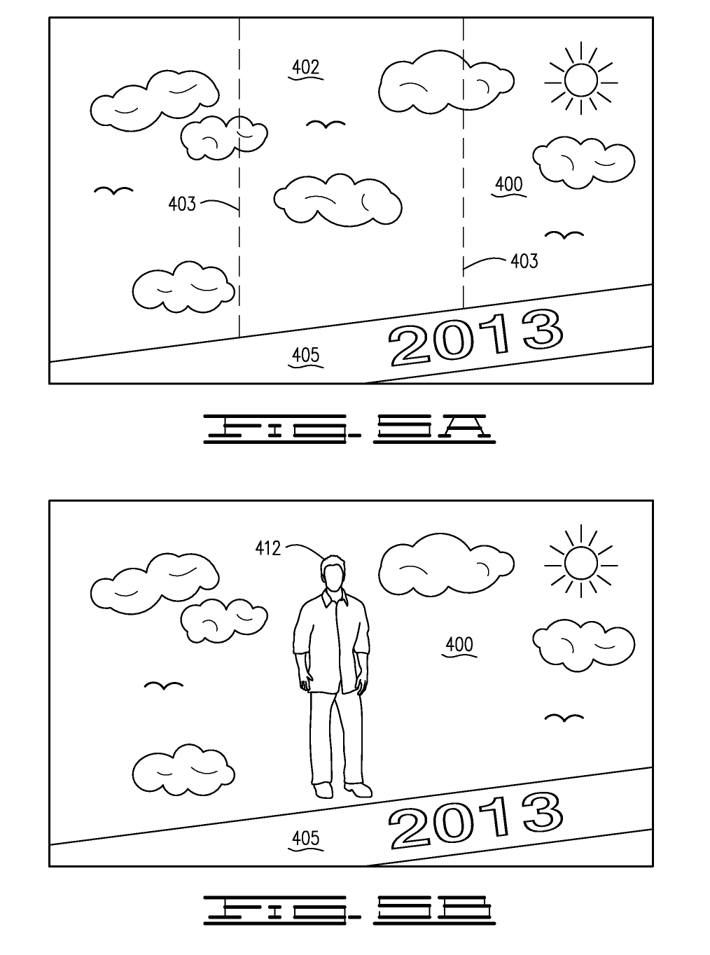

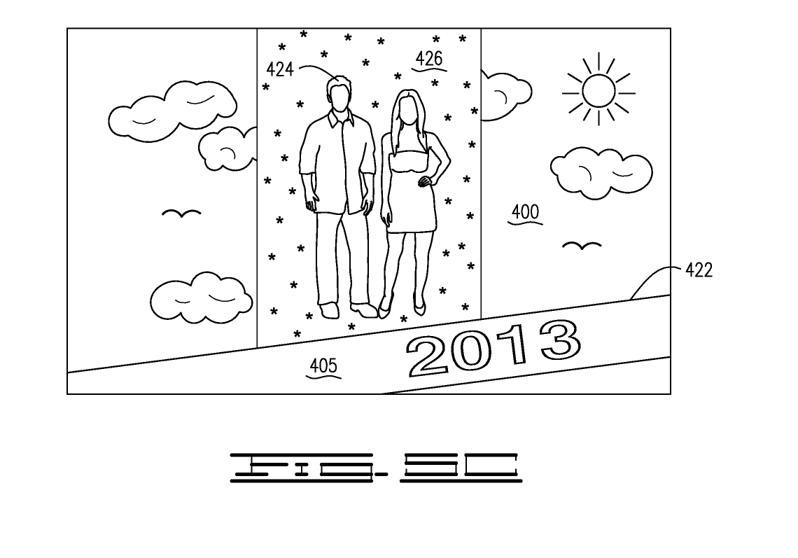

Chroma key backgrounds are desirable because they allow the background to be readily changed during the processing phase or the sales phase. Chroma keying is a technique for blending two or more images together in which a color, or a small range of colors, is removed from one image and replaced with another image. This technique is also known as color keying, green-screening and blue-screening. Basically, a photograph is taken of a subject, such as a person or persons, an object or objects, or any combination thereof, in front of a solid colored background. Later, the solid colored background is removed. This new photograph without a background is then placed over a different background. This process allows for the background of the photograph to be chosen after the photograph is taken. Further, it allows for the same photograph to have multiple different backgrounds. This means that the same photograph can be purchased with different backgrounds. If a chroma key background is utilized, instructions can be provided to assist event attendees in taking the chroma key picture; thus reducing or eliminating the need to have a professional photographer at the event. An example of a digital image where the background has been changed by a chroma key process is shown in FIG. 5B. In FIG. 5B the original background has been removed (or rendered transparent as described below). This leaves only the subject 412, which is placed over the predetermined background 400, shown without the subject in FIG. 5A.

Superimposing is a process wherein at least a portion of the image is superimposed onto a predetermined background or wherein a predetermined foreground is superimposed onto the image. As used herein, “superimposing” refers to a process where the background is not removed or rendered transparent by a chroma key process, although background can be removed by cropping. An example of a processed image produced by a superimposing process is shown in FIG. 5C. For superimposing, predetermined background 400 has a subject region defined. The subject region is shown in FIG. 5A where it is the area between dotted lines 403. The digital image can adjusted to fit into the subject region, such as by being cropped or being enlarged or reduced in size. Accordingly, in FIG. 5C, a digital image has been cropped to fit into the subject region by removing a portion of the digital image below line 422 and then superimposed on background 400 so as to cover the subject region. Accordingly, subject 424 is surrounded by a portion of the original or native background 426, which is surrounded by the predetermined background 400. Alternatively, banner 405 could be a predetermined foreground, which is superimposed onto the digital image and/or predetermined background 400.

Returning now to FIG. 1, in step 12, the customer attaches the digital image to a digital message and sends it to the automated processor. As discussed above, the digital message may be sent from any suitable device. In one embodiment, a message sending station, such as a computer with Internet access, can be set up at the event so that customers can upload digital images from a digital capture device and send digital messages containing one or more images to the automated processor, or upload the digital images directly to the automated processor at a predefined digital messaging address. In another embodiment of the invention, the digital capture device has digital messaging capability and the digital message is sent from the digital capture device. For both of these embodiments, the processed digital images can become available relatively quickly compared with prior image processing processes. Thus, in accordance with the invention, the processed digital image can become available by a return digital message and/or at a webpage during the period of time which the event is going on (“event timeframe”) so that customers can view the processed digital image and/or modify the image and purchase prints and products during the event. The return digital message or webpage is generated by the automated processor, as described below, and can be viewed through the digital capture device, if it has digital messaging or Internet capability, or through another digital messaging or Internet connected device, such as a computer with Internet access, which could be the message sending station. Accordingly, it is preferred that the time period between the customer sending the digital message to the automated processor and the return transmission phase, i.e., the processed digital image and/or webpage being sent by the return digital message to the customer or event associate, be less than the event timeframe. Generally, this time period can be less than an hour and preferably can be less than half an hour, can be less than 15 minutes or can be less than ten minutes. Additionally, in another embodiment, the customer can send the digital images from a home computer or office computer subsequent to the event; however, this embodiment would not allow processed images to be available at the event.

The digital message is sent to the automated processor at a predetermined digital address, which can be a general digital address assigned to the automated processor but, in one embodiment, is an event specific address assigned to the automated processor. By use of an event specific address, digital images sent to the automated processor may be collected in a database in accordance with the event at which they were taken, thus allowing later review of all images for an event at a webpage or group of webpages. Generally, this webpage or group of webpages can be accessible at a website. Accordingly, by collecting the digital images in accordance with the event at which they were taken, a user can select a specific event at the website and access the webpage or group of webpages associated with that specific event.

In step 14, the digital message is received at the automated processor and, if used, can be categorized by the event specific address. In step 16, the customer's digital address is extracted to provide a return address to send an email to the customer per step 22 and/or step 28, described below. The extraction of the digital address can be a direct extraction of the digital address from which the digital message is sent, such as an e-mail address of the e-mail account used to send the digital message or a telephone number used to send a text message. Optionally, the digital message can have a pre-assigned account number in its subject line or text body. The account number can be a unique name, number or mixture of letters, numbers and/or symbols, which are used to identify the customer. The account number is established prior to sending the digital message but can be assigned prior to, during or subsequent to the event. The account number correlates with a customer account or database having information on each customer, such as name, digital address and similar. Having an event specific address and identifying the customer by digital address and/or account number allows cross-categorizing by both the event specific address and by the customer's identity. Thus, for example, digital images received by the automated processor can be categorized by the event and subcategorized by customer. Accordingly, at the website a user can select the specific event to access the group of webpages associated with the specific event and then select one or more of webpages of the group of webpages by customer identity so that the user can access the digital images, which generally will be the processed digital image, submitted by a specific customer at a specific event. Additionally, digital images for a specific event could be subcategorized into webpages by other criteria, such as time intervals in which the digital images were taken or shirt colors at events such as races or other sporting events.

In step 18, the digital image is extracted from the digital message and then, in step 20, is evaluated for image quality to determine if the image meets predetermined criteria. The evaluation of the image quality can, alternatively, be included as part of the digital image processing of step 24. Thus, for example, the image may be checked to determine if it is in a valid format and/or the resolution of the digital image can be checked to determine if it meets a predetermined threshold value. If the image quality meets or exceeds the predetermined criteria, the automated processor goes on to step 24. If the threshold value is not met, the automated processor goes to step 22 and sends a warning message, typically an email or text message, to the customer informing the customer that the image quality was not sufficient. Additionally, the warning message of step 22 can be sent if there are other errors, such as if an image has not been included with the digital message. If the image resolution did not meet the predetermined threshold value, the automated processor can, in addition to sending out the warning message of step 22, proceed to step 24 and process the lower quality image as it would an image meeting the predetermined threshold value; however, the quality of the processed image could be low.

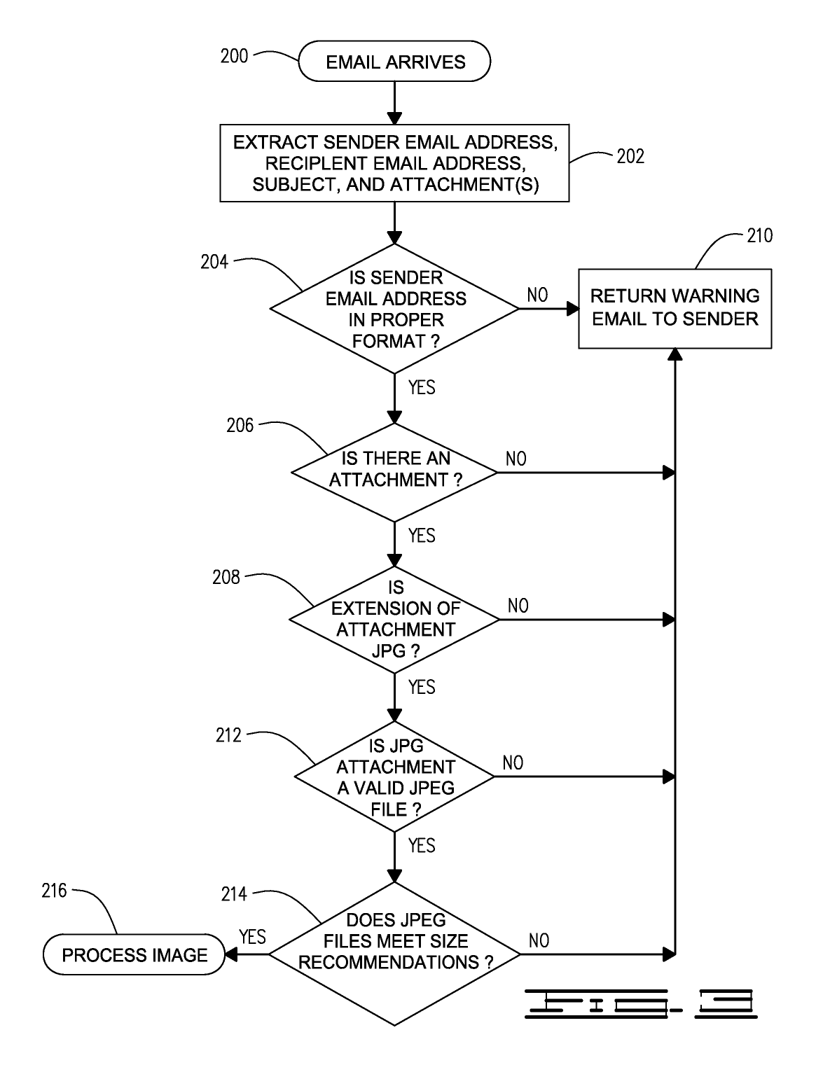

Turning to FIG. 3, an exemplary process for the evaluation of image quality is shown in further detail. In step 200, which is the equivalent of step 14 in FIG. 1, the email is received by the processor and the sender email address, recipient email address, subject and one or more attachments (digital images) are extracted in step 202. During the extraction, the sender email address is checked for a proper format in step 204 and the existence of least one attachment is checked in step 206. If the sender email address is not in a proper format or if there is no attachment, a warning message is generated and sent in step 210. After extraction, each attachment's file extension is checked to make sure it is an extension for an acceptable file format in step 208. In the example illustrated in FIG. 3, the acceptable extension is jpg, that is, one for a JPEG file format. If the file extension is not acceptable, a warning message is generated and sent in step 210. Next, the attachment is checked in step 212 to make sure that the attachment is a valid file in the format of the extension. Thus, if the extension is jpg and the file is not in JPEG file format, the processor will generate a warning and send a warning message in step 210. Finally, the attachment is checked in step 214 to determine if the size recommendation for images is met. If not, again, a warning message is generated and sent in step 210. If so, the file is passed to step 216, which is equivalent to step 24 in FIG. 1, for further processing.

Returning now to FIG. 1, the digital image is processed in step 24 to produce a processed digital image also called herein a processed image. The processing can include many digital image processing techniques and will usually include one more of the processing techniques selected from the group consisting of chroma sub-sampling the digital image, conversion of the digital image to an alpha channel format, replacing the background, superimposing the digital image onto a predetermined background, and superimposing a predetermined background onto the digital image. Additionally, the processing can include other known digital image processing techniques. Generally, if and what digital processing is performed can be selected by the customer. Such selection can be made in advance of sending the digital image or can be designated in the digital message by tag words, which are recognized by the processor as being associated with specific types of digital processing.

In one embodiment, if a digital image taken with a chroma key background is sent in JPEG format, the digital image can be converted to an alpha channel format such as TIFF, PNG, and Photoshop® files. An alpha channel defines the transparency of the pixels of the digital image, whereby each pixel can have a specified transparency such that the pixel can be opaque, transparent, or somewhere in between. If the file format of the digital image supports alpha channels, then the image can be saved with the background removed by setting those corresponding pixels to transparent. File formats that include an alpha channel are TIFF, PNG, and Photoshop® formats. PNG format is preferable as it is a “lossless” format that is easily manipulated in many programming languages, including web-programming languages such as PHP. Some file formats, however, such as the JPEG format, do not support alpha channels. Therefore, the photograph without the background cannot be saved as a JPEG format.

The converted digital image can then have the chroma key background replaced by techniques known in the art with a preselected event background to produce an event background image. Generally, the preselected or predetermined background will be chosen from event-related backgrounds such as the alternative backgrounds described below. The converted digital image can also be saved so that it is available at a webpage allowing the customer to choose alternative backgrounds, as further described below.

The drawback of the file formats that include an alpha channel is that they tend to be large in size and accordingly the converted digital image can be chroma sub-sampled to reduce the image file size. Chroma subsampling is a process of reducing (or compressing) the size of the digital image by sampling the chroma or color components to reduce the color data while retaining the luma or brightness component data. Because human visual system is less sensitive to the variations in color than to variations in brightness, chroma subsampling reduces the image file size with little noticeable reduction in image quality. Additionally, the event background image can be chroma sub-sampled and/or converted to a non-alpha channel format, such as JPEG, to reduce the image file size so that it is more suitable to return the processed digital image in a digital message to the customer.

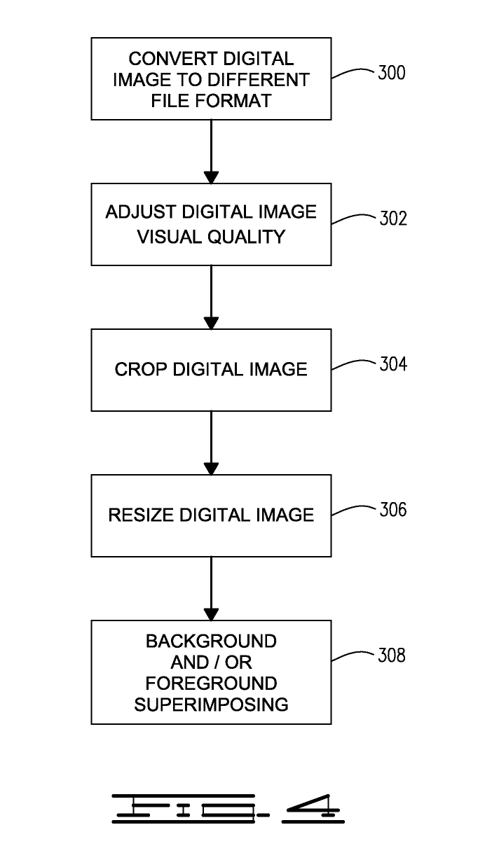

Another embodiment is illustrated in FIG. 4. The digital image received by the automated processor can be converted to a different file format in step 300, if desired or necessary for processing. Additionally, in step 302 adjustments to the image color, tint, contrast, darkness and similar can be made as described below to make the image more visually appealing. The digital image in this embodiment is taken with a native background and can be adjusted, if necessary, to better fit in the subject region (described above), such as by being cropped in step 304 or being enlarged or reduced in size in step 306. After cropping or resizing, the digital image is superimposed upon the predetermined background in step 308 so as to cover the subject region and produce the processed image. Alternatively or in addition to background superimposing, a predetermined foreground may be superimposed onto the digital image.

Additionally, predetermined thresholds can be set up for image color, tint and darkness and adjustments can be made to produce a sharper more visually appealing image. Also, watermarks may be added to the processed digital image to protect against misappropriation. After processing is complete the thus produced processed digital image is ready to send to the customer and as indicated above, a webpage can be created, step 26, to store a version of the image, typically an alpha channel version, for later viewing and adjustment by the customer. Optionally, the processed digital image can be posted to a preexisting webpage.

Turning now to step 28, a digital message (or return digital message) containing the processed image and/or a link to the webpage address for the image is sent to the customer. Additionally, a similar digital message can be sent to the event associate, step 32. The return digital message can be any suitable digital message, such as email, text messaging, or the like, but will generally be the same type as sent by the customer. If customer accounts are used, the customer account could direct a different format for the digital message.

In steps 30 and 34 the customer and/or the event associate can access the webpage. Additionally, other people can access the webpage. Such other people can be anyone accessing the website hosting the webpage or can be limited to event associates or limited to those allowed by the customer or event sponsor. The user accessing the webpage can further process the digital image sent by the customer by selecting different processing options. The processing options can include one or more of the options selected from the group consisting of cropping the image, enlargement of the digital image, reduction of the digital image, selecting different backgrounds, adding text, adding graphics or choosing effects. Effects can include, for example, converting the image to black-and-white or sepia tone. Different or alternative backgrounds can be selected from event specific backgrounds; thus, for example, for a pirate themed party the chroma key background could be replaced with a pirate ship or tropical island or the digital image can be superimposed on the pirate ship or tropical island background. For a graduation ceremony the alternative backgrounds could include campus shots or school colors. Additionally, the alternative backgrounds can be selected from non-event specific backgrounds such as flowers, landscapes, fireworks, and the like. Also, different or alternative foregrounds, such as banners, text bubbles and similar, can be selected and superimposed onto the digital image. After making any such alterations, the user can choose to order prints of the processed digital image, can choose as many copies of the print as the user desires and can choose print sizes or can choose other products where the image appears on the product. Products can include t-shirts, aprons, towels, cards, calendars, and the like. The products can also include user designed photograph books, such as collections of prints of processed digital images from the event or from several such events. The user pays for the order electronically and the order is submitted to a fulfiller for fulfillment. The fulfiller will generally be a business that produces and/or supplies prints or the other products. When the order is fulfilled, the product or products are sent to the user.

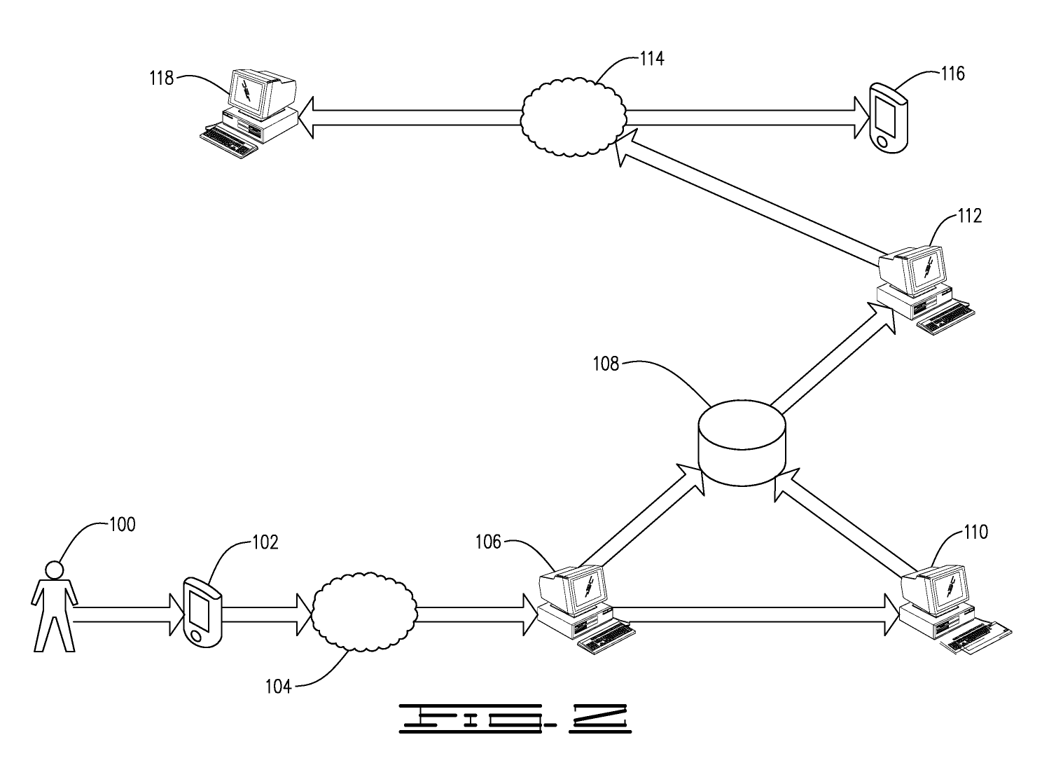

Turning now to FIG. 2, an embodiment of the current invention is illustrated. Customer 100 at an event shoots with his digital camera or cell phone to capture a digital image. The customer then sends e-mail 102, with the digital image attached to the email, through the Internet 104 to be received at automatic processor 106. The e-mail and image are stored in database 108. The image can be processed by automated processor 110 using chroma key software to remove the background and produce a PNG file or using a superimposing process as described above. Accordingly, a preselected event background can be added. The processed image is stored in database 108. Upon production of the processed image, an email 112 is produced with the processed image having the preselected background and with a link to an order webpage. The email 112 is sent through the Internet 114 to both the customer at the event 116 and the event associate 118. Upon receipt of the email 112, the customer can view the image having the preselected background and can access the webpage to select and view prints or products of the image with the preselected background or select and view alternative backgrounds and purchase prints or products with the alternative background. Advantageously, the described method allows the customer 100 to both send the digital image to the automated processor 106 via Internet 104 and receive the processed image 110 and webpage link while still at the event. As illustrated, the automated processor 106 will generally be a computer or other CPU-type device which is pre-programmed to process the image based upon the specific event and/or specific customer. The automated processor can be set up to have little and, preferably, no human input during the processing of the digital image as such human input would slow down the processing and impede or prevent obtaining the advantage of having the processed digital image available during the event timeframe. Thus, for example, if the digital message from the customer is sent to an event specific address, automated processor 106 can identify the event by the event specific address, replace the chroma key background with the appropriate event specific pre-selected background during the processing of the digital image, and send return email 112 during the event timeframe.

Other embodiments of the current invention will be apparent to those skilled in the art from a consideration of this specification or practice of the invention disclosed herein. Thus, the foregoing specification is considered merely exemplary of the current invention with the true scope thereof being defined by the following claims.

What is claimed is:

1. A method of processing digital images comprising:
(a) receiving a digital image sent by a first digital message wherein the image has a subject in front of a background;
(b) extracting a return address from the first digital message by an automated processor;
(c) extracting the digital image from the first digital message by the automated processor;
(d) processing the digital image by the automated processor to produce a processed image wherein the processing comprises superimposing; and
(e) returning the processed image to the return address by a second digital message wherein the second digital message is sent by the automated processor.

2. The method of claim 1, wherein said superimposing in step (d) comprises superimposing at least a portion of said digital image onto a predetermined background.

3. The method of claim 2 wherein step (d) further comprises adjusting the digital image so that the digital image conforms to a predetermined area on said predetermined background.

4. The method of claim 3 wherein the adjusting of the digital image comprises one or more of cropping the digital image, changing the size of the digital image by reduction and changing the size of the digital image by enlargement.

5. The method of claim 2 wherein the digital image is captured at an event and the predetermined background is an event specific background predetermined for the event at which the digital image is captured.

6. The method of claim 1 wherein said superimposing in step (d) comprises superimposing a predetermined foreground onto said digital image.

7. The method of claim 1 wherein the digital image has been captured at an event, attached to a digital message and sent to a digital address.

8. The method of claim 7 wherein the first digital message is received in step (a) at the digital address and wherein the digital address is an event specific address that is predetermined for the event at which the digital image is captured.

9. The method of claim 8 wherein the image is captured using a digital capture device having digital messaging capability and the digital message is sent from the digital capture device.

10. The method of claim 1 wherein the first digital message is received in step (a) at an event specific address that is predetermined for an event at which the digital image is captured.

11. The method of claim 10 wherein the first digital message is an e-mail message and the event specific address is an event specific e-mail address.

12. The method of claim 10 wherein the first digital message is a text message and the event specific address is an event specific phone number.

13. The method of claim 1 wherein the return address is extracted from the first digital message based on a digital address from which the first digital message was sent.

14. The method of claim 1 wherein the return address is extracted from the first digital message by correlation of an account number in the first digital message with a previously registered digital address.

15. The method of claim 1 wherein the digital image has a resolution and the processing the digital image in step (d) further includes one or more processing techniques selected from the group consisting of sub-sampling the digital image, conversion of the digital image to an alpha channel format; determining if the resolution of the image meets a predetermined threshold; adjusting the color; and adjusting the tint.

16. The method of claim 1 wherein the digital image has a resolution and processing the digital image in step (d) includes determining if the resolution of the image meets a predetermined threshold.

17. The method of claim 16 wherein, if the digital image does not meet the predetermined threshold, the automated processor sends a digital warning message to the return address.

18. The method of claim 1 wherein the second digital message includes an Internet link of a webpage where the image can be altered.

19. The method of claim 18 wherein the image can be altered at the webpage by a processing option selected from one or more of the group consisting of cropping the image, enlarging the digital image, reducing the digital image, selecting different backgrounds, adding text, adding graphics and choosing effects.

20. The method of claim 18 wherein the webpage includes allowing the purchase of prints and products utilizing the digital image.

21. A method of processing digital images comprising:
(a) receiving a first digital message containing a digital image sent by a digital capture device to an event specific digital address that is predetermined for an event at which the digital image is captured wherein said digital image has a resolution, the digital image being of a subject at an event wherein the subject is in front of a background and the image is captured using a digital capture device having digital messaging capacity;
(b) extracting a return address from the first digital message by an automated processor;
(c) extracting the digital image from the first digital message by the automated processor;
(d) determining by the automated processor if the resolution of the digital image meets a predetermined threshold by the automated processor wherein, if the threshold is not met, the automated processor sends a digital warning message to the return address;
(e) processing the digital image by the automated processor to produce a processed image having an event specific background predetermined for the event and wherein the processing comprises adjusting the digital image by one or more of cropping the digital image, changing the size of the digital image by reduction and changing the size of the digital image by enlargement so that the digital image conforms to a predetermined area on the event specific background, superimposing at least a portion of the digital image onto the event specific background and superimposing a predetermined foreground onto the event specific background;
(f) returning the processed image to the return address by a second digital message wherein the second digital message is sent by the automated processor and wherein the second digital message includes an Internet link of a webpage where the image can be altered and the webpage includes options for the purchase of prints and products utilizing the digital image.
